(19) United States
(12) Patent Application Publication
(10) Pub. No.: US 2018/0111792 A1
(43) Pub. Date: Apr. 26, 2018

(54) ELEVATOR VIRTUAL HALL CALL PANEL SYSTEMS AND METHODS OF OPERATION

(71) Applicant: Otis Elevator Company, Farmington, CT (US)

(72) Inventors: Clement Schach, Orleans (FR); Gilles Bruno, Chateauneuf Sur Loire (FR)

(21) Appl. No.: 15/728,574

(22) Filed: Oct. 10, 2017

(30) Foreign Application Priority Data
Oct. 26, 2016 (EP) 16290204.3

(51) Int. Cl. B66B 1/46; B66B 3/00; B66B 5/00

(52) U.S. Cl. CPC B66B 1/468; B66B 3/002; B66B 5/0012; B66B 2201/4615; B66B 2201/101; B66B 2201/102; B66B 2201/463; B66B 2201/103

(57) ABSTRACT

Virtual hall call panel systems for elevator landings and methods of use are provided. The systems include a display and detection assembly positioned proximate an elevator landing door, the display and detection assembly including a projection device and a detection device, a display surface proximate the display and detection assembly configured to display a display image projected by the projection device of the display and detection assembly, and a controller configured to receive input from the display and detection assembly, the controller configured to determine an input based on a detected object detected by the detection device and send a signal based on the input to control an elevator system.

### CROSS-REFERENCE TO RELATED APPLICATIONS

This application claims the benefit of European Application No. 16290204.3 filed on Oct. 26, 2016, which is incorporated herein by reference in its entirety.

### BACKGROUND

The subject matter disclosed herein generally relates to elevator systems and, more particularly, to hall call panel systems for operating elevator systems.

Elevators are provided with user interfaces to enable passengers to access and use the elevator (e.g., to call elevator cars to travel to different floors within a building). One type of such user interface is a hall call panel located proximate an elevator landing door in a hallway, lobby, or landing of an elevator system. The hall call panel is a user interface device (e.g., operating panel) that is located on a landing of the elevator system (e.g., hallway, lobby, etc.) and traditionally is located near or proximate to elevator landing doors. Such hall call panels can be configured to enable passengers to call elevator cars and to provide information to potential passengers (e.g., indicating that an elevator car has already been called). The hall call panels are traditionally bulky and are electromechanical devices that are installed into a frame or wall near elevator landing doors. It may be advantageous to provide improved and useful hall call panels for elevator landings that can provide additional functionality.

### SUMMARY

According to one embodiment, a virtual hall call panel system for an elevator landing is provided. The system includes a display and detection assembly positioned proximate an elevator landing door, the display and detection assembly including a projection device and a detection device, a display surface proximate the display and detection assembly configured to display a display image projected by the projection device of the display and detection assembly, and a controller configured to receive input from the display and detection assembly, the controller configured to determine an input based on a detected object detected by the detection device and send a signal based on the input to control an elevator system.

In addition to one or more of the features described herein, or as an alternative, further embodiments of the virtual hall call panel system may include a proximity sensor configured to detect the presence of a passenger within a predetermined proximity to the display and detection assembly.

In addition to one or more of the features described herein, or as an alternative, further embodiments of the virtual hall call panel system may include that the controller is configured to control the display and detection assembly to project the display image when a passenger is detected within the predetermined proximity.

In addition to one or more of the features described herein, or as an alternative, further embodiments of the virtual hall call panel system may include that the display surface is one of an elevator landing door frame or a wall of a building.

In addition to one or more of the features described herein, or as an alternative, further embodiments of the virtual hall call panel system may include that the display image is at least one of (i) arrows indicating a direction to call an elevator car, (ii) an alpha-numeric keypad, or (iii) an informational notice.

In addition to one or more of the features described herein, or as an alternative, further embodiments of the virtual hall call panel system may include that the controller is configured to change the display image projected by the display and detection assembly based on an operating mode of an elevator.

In addition to one or more of the features described herein, or as an alternative, further embodiments of the virtual hall call panel system may include that the display image is at least one of an image, a drawing, a symbol, an icon, or text.

According to one embodiment, a method for controlling an elevator using a virtual hall call panel for an elevator landing is provided. The method includes displaying a display image on a display surface using a display and detection assembly positioned proximate an elevator landing door, the display and detection assembly including a projection device and a detection device, detecting input from a passenger with the detection device, the input associated with the display image, and transmitting a control signal to control an elevator based on the input.

In addition to one or more of the features described herein, or as an alternative, further embodiments of the method may include detecting the presence of a passenger within a predetermined proximity to the display and detection assembly with a proximity sensor.

In addition to one or more of the features described herein, or as an alternative, further embodiments of the method may include projecting the display image when a passenger is detected within the predetermined proximity.

In addition to one or more of the features described herein, or as an alternative, further embodiments of the method may include that the display surface is one of an elevator landing door frame or a wall of a building.

In addition to one or more of the features described herein, or as an alternative, further embodiments of the method may include that the display image is at least one of (i) arrows indicating a direction to call an elevator car, (ii) an alpha-numeric keypad, or (iii) an informational notice.

In addition to one or more of the features described herein, or as an alternative, further embodiments of the method may include changing the display image projected by the display and detection assembly based on an operating mode of an elevator.

In addition to one or more of the features described herein, or as an alternative, further embodiments of the method may include that the display image is at least one of an image, a drawing, a symbol, an icon, or text.

In addition to one or more of the features described herein, or as an alternative, further embodiments of the method may include disabling the detection device based on an operating mode of an elevator.

Technical effects of embodiments of the present disclosure include virtual hall call panels for elevator systems that are customizable and controllable to enable information presentation, elevator control, and/or other features.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing floor of an elevator system with a hall call panel that may employ various embodiments of the present disclosure;

FIG. 3 is a schematic illustration of a landing floor of an elevator system incorporating a virtual hall call panel in accordance with an embodiment of the present disclosure;

FIG. 4A is a schematic illustration of a virtual hall call panel in a state when a passenger is not proximate to the virtual hall call panel (e.g., not present), in accordance with an embodiment of the present disclosure;

FIG. 4B is a schematic illustration of the virtual hall call panel of FIG. 4A when a passenger is in proximity to the virtual hall call panel;

FIG. 5A is a schematic illustration of one example display image achieved with embodiments of the present disclosure;

FIG. 5B is a schematic illustration of another example display image as produced by embodiments of the present disclosure;

FIG. 5C is a schematic illustration of another example display image as produced by embodiments of the present disclosure;

FIG. 6 is a schematic illustration of an alternative configuration of an elevator landing incorporating a virtual hall call panel in accordance with an embodiment of the present disclosure;

FIG. 7 is a flow process for operating or controlling an elevator system using a virtual hall call panel in accordance with an embodiment of the present disclosure; and

FIG. 8 is a flow process for operating or controlling an elevator system using a virtual hall call panel in accordance with another embodiment of the present disclosure

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “##” that is shown in FIG. X may be labeled “X##” and a similar feature in FIG. Z may be labeled “Z##.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

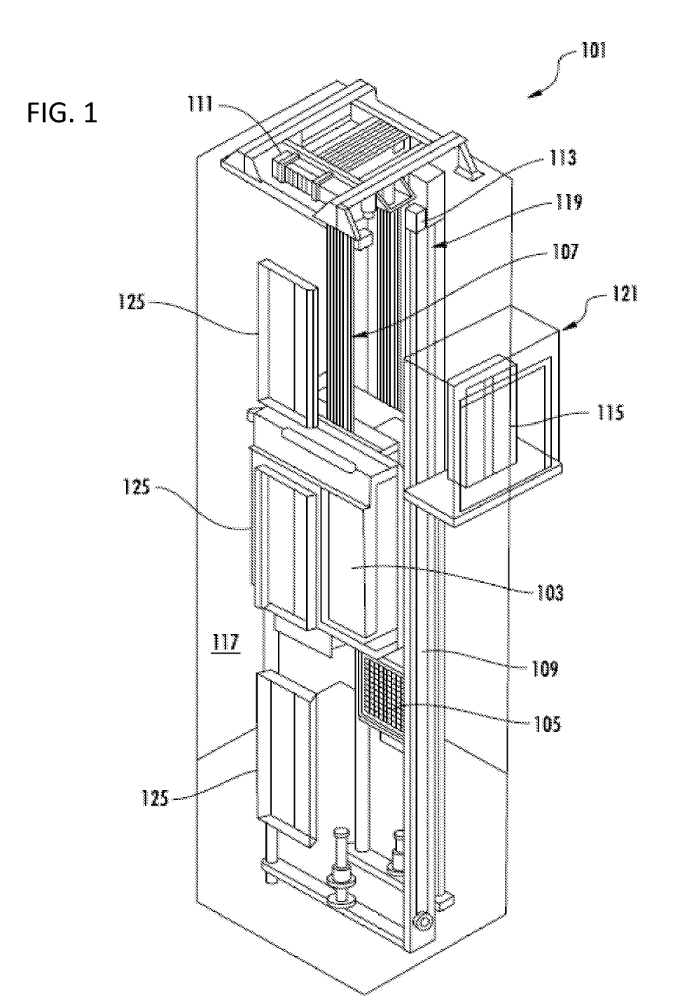

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

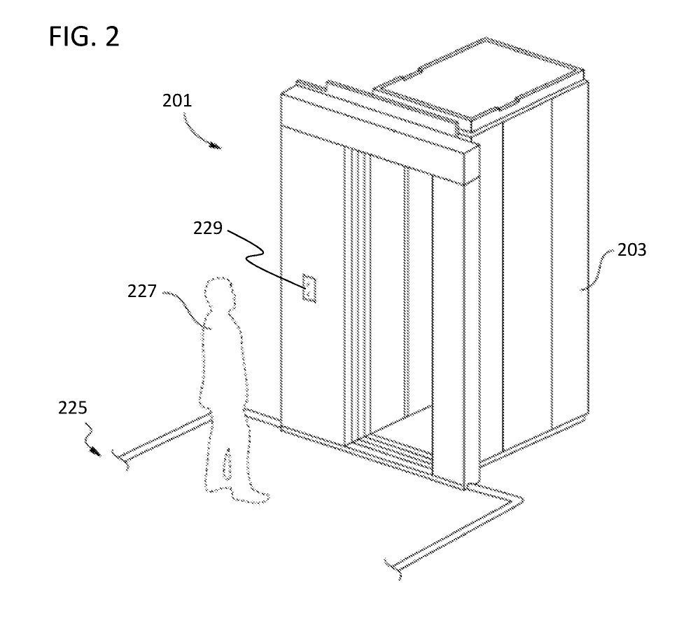

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a passenger or mechanic 227 that desires to travel to another floor within a building using a hall call panel 229. Traditional hall call panels 229 are physical, mechanical, and/or electromechanical components that are installed into the wall or framing about an elevator landing door. Hall call panels can be used as an interface command to call an elevator and also can provide an indication to a user to inform such user about a status of the elevator request or elevator car arrival. Embodiments provided herein are directed to hall call panels that provide customizable and/or programmable display (e.g., virtual display) and interaction. Such hall call panels can be universally adaptable and may not be limited by size and configuration of a framing about an elevator landing door. Further, hall call panels in accordance with the present disclosure can be changeable to provide information, notices, various interactions, etc.

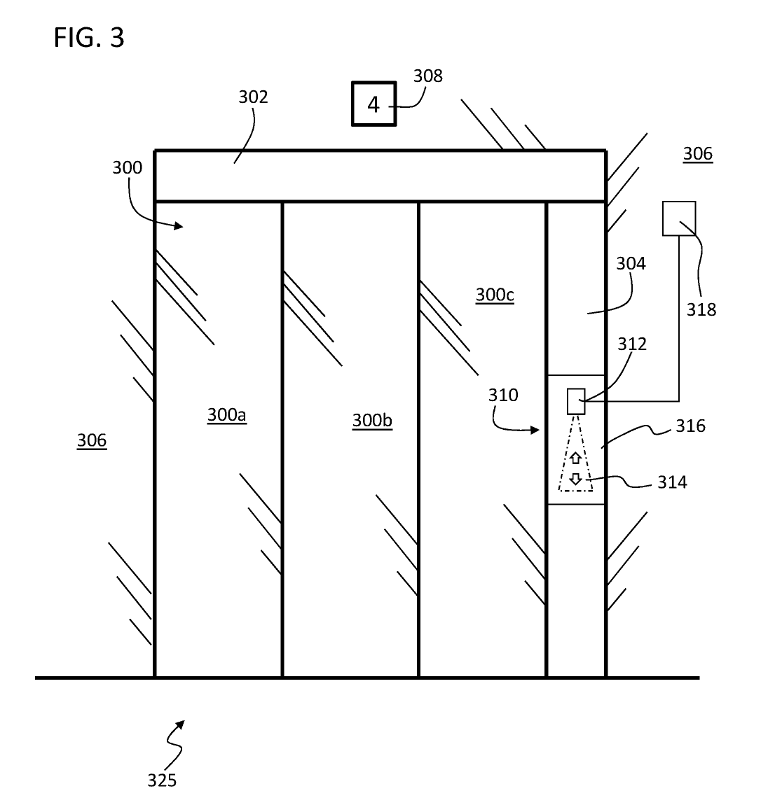

Turning now to FIG. 3, a schematic illustration of an elevator landing 325 incorporating an embodiment of the present disclosure is shown. As shown, the landing 325 includes an elevator landing door 300 that, as shown, includes three door panels 300a, 300b, 300c that can slide or translate to open when an elevator car is present at the landing door 300. The landing door 300 is housed within a door frame that includes a lintel 302 and one or more frame portions 304. As shown, the lintel 302 is positioned above the landing door 300 and the frame portion 304 is to the side and extends vertically from the floor to the lintel 302. The frame (e.g., the lintel 302 and the frame portions 304) are mounted within a wall 306 of the building in which an elevator system is located.

As shown, an elevator status indicator 308 is positioned above the lintel 302 and can be used to display the current location of an elevator car that services the landing door 300. The elevator car can be called by a user (e.g., passenger) by operation of a virtual hall call panel system 310. The virtual hall call panel system 310, as shown, is a digital and virtual hall call panel system. That is, the virtual hall call panel system 310 in accordance with the embodiment of FIG. 3 includes a display and detection assembly 312 that is configured to project a display image 314 on a display surface 316 and detect interaction with the display image 314.

The display and detection assembly 312 includes, at least, a projection device and a detection device. The projection device can be an optical projector that is configured to project images from the display device onto the display surface 316. The configuration and components of the projection device can be selected to project an image onto the display surface 316 (e.g., based on material, texture, angle, etc. of the display surface 316). The projection device can include LED lights or other optical illumination components. The detection device can be, in some embodiments, an optical detector that can detect a reflection of the projection device. Alternatively, in some embodiments, the detection device can include a non-visible spectrum projection element and an associated detector (e.g., IR detection) to enable detection of an object located proximate to the detection device. In some embodiments, the projection device and detection device can be housed in a single housing or enclosure, and in other embodiments, the projection device and the detection device can be housed separate from each other.

As illustrated, the display image 314 includes an up arrow and a down arrow that are used to allow a user to indicate a direction the user would like to travel. That is, the display image 314 can be configured to display a digital version of a traditional, physical hall call button. However, in accordance with embodiments of the present disclosure, the arrows are optically produced by projecting an image onto the display surface 316. While projecting the display image 314, the display and detection assembly 312 is configured to detect interruptions with the displaying of the display image 314. That is, the display and detection assembly 312 is configured to detect a user interacting with the display image 314. For example, the detection feature of the display and detection assembly 312 can use reflection monitoring to determine the presence of an object (e.g., a hand or finger; hereinafter “detected object”) below the display and detection assembly 312 such that a distance (and thus position) of the detected object can be determined. Based on this, the display and detection assembly 312 can generate an appropriate signal that is sent to an elevator controller to call an elevator car going in the appropriate direction.

As shown, the display surface 316 is a distinct or separate feature on the frame portion 304. In such configurations, the display surface 316 can be formed from a predetermined material, texture, paint, inclination (e.g., tilted surface), etc. that can be used for displaying the display image 314. However, in some embodiments, the display surface 316 can be integral with the frame portion 304 or in some embodiments, depending on the location of the display and detection assembly 312, the display surface 316 can be on the wall 306.

Control of the display and detection assembly 312 can be implemented within the display and detection assembly 312 or a controller 318 may be separate therefrom, e.g., as shown in FIG. 3. For example, in some embodiments, a microprocessor and associated electronics can be housed within the display and detection assembly 312 and/or within the frame portion 304 (or in other location behind the display and detection assembly 312). In other embodiments, such as shown in FIG. 3, a controller 318 can be in communication with the display and detection assembly 312 such that display information and/or detection information can be sent to and from the display and detection assembly 312 and the controller 318. The communication between the controller 318 and the display and detection assembly 312 can be through wired or wireless communication. In some embodiments, the controller 318 may be part of or integral with an elevator controller (e.g., elevator controller 115 shown in FIG. 1).

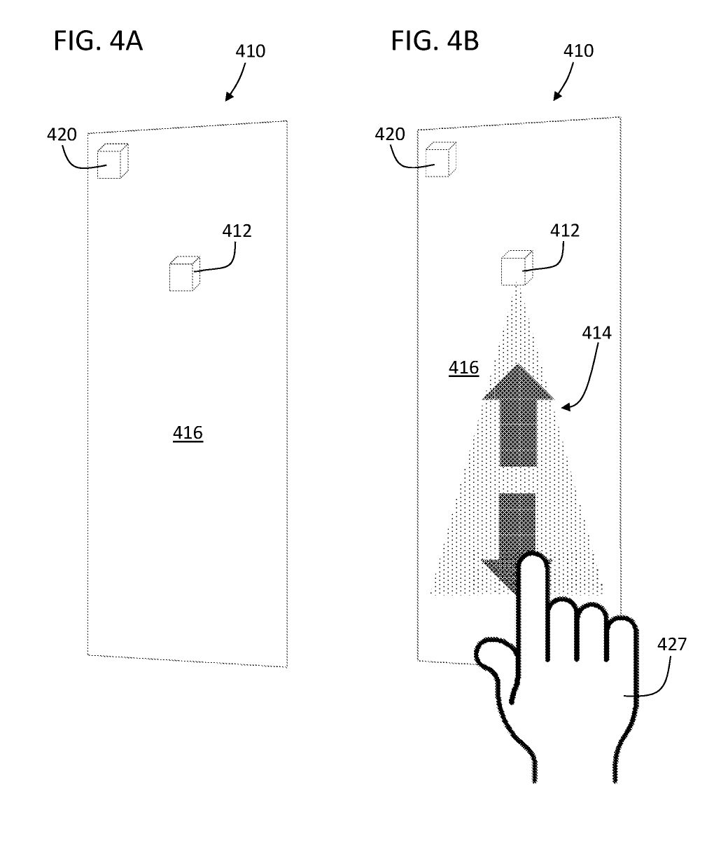

Turning now to FIGS. 4A-4B, schematic illustrations of a virtual hall call panel system 410 in accordance with an embodiment of the present disclosure are shown. The virtual hall call panel system 410 is similar to that described above, with the virtual hall call panel system 410 being in operable communication with a controller that is part of the virtual hall call panel system 410 and/or part of an elevator controller. The virtual hall call panel system 410 includes a display and detection assembly 412 and a display surface 416. In the embodiment of FIGS. 4A-4B, the virtual hall call panel system 410 also includes an optional proximity sensor 420 that can be electrically coupled to or otherwise connected to or in communication with the display and detection assembly 412 and or the controller. In embodiments that do not include a proximity sensor, the display and detection assembly 412 can be “always on” or programmed to be on during certain predetermined times and/or events.

The proximity sensor 420 is configured to detect the presence of a passenger 427 near the display and detection assembly 412. In such an embodiment, the display and detection assembly 412 is configured to project a display image 414 on the display surface 416 when a passenger 427 is detected within a predetermined distance or area of the virtual hall call panel system 410. In some embodiments, the proximity sensor 420 can be configured to detect the presence of a hand or other feature of a passenger that is attempting to call an elevator car. However, in other embodiments, the proximity sensor 420 can have a larger range of detection such that when a potential passenger walks near the virtual hall call panel system 410 (e.g., approaches the elevator landing doors), the proximity sensor 420 can prompt the display and detection assembly 412 to project the display image 414 onto the display surface 416. In some embodiments, the proximity sensor 420 can be integrated into the display and detection assembly 412.

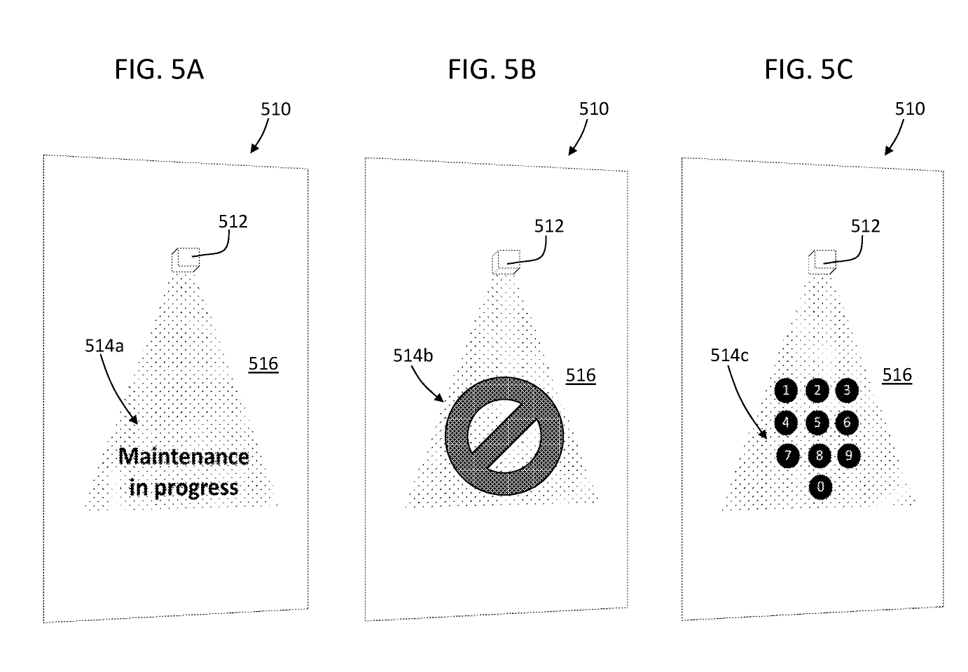

As noted above, the display and detection assembly of the present disclosure can be customizable or programmable. For example, turning now to FIGS. 5A-5C, example display images 514a, 514b, 514c generated by a virtual hall call panel system 510 in accordance with embodiments of the present disclosure are shown. In FIGS. 5A-5C, a display and detection assembly 512 is programmable to generate and project one or more predetermined images, such as display images 514a, 514b, 514c on a display surface 516.

As shown in FIG. 5A, text or other notices can be displayed as the display image 514a. For example, as shown, the display image 514a is a notice to any passengers that maintenance is in progress, thus indicating that the elevator may not be in service. In some configurations, the display image can change over time. For example, an image of “maintenance in progress” can be displayed for a predetermined time (e.g., 5 seconds) and then a second display image can be displayed, for example, stating “out of service,” which can also be displayed for a predetermined time. Accordingly, multiple different messages or images can be displayed in a predetermined order and/or can be changed.

In addition to displaying text, the display and detection assembly 512 can project an image, drawing, symbol, icon, etc. such as shown as display image 514b. In some embodiments, the display and detection assembly 512 can be configured to switch between an image, drawing, symbol, icon, etc. (e.g., FIG. 5B) and text (e.g., FIG. 5A), to provide different means of conveying a single idea (e.g., elevator is out of service). Other icons or images are possible as well. For example, as shown in FIG. 4B, the display image can include arrows that are used to indicate direction and enable interaction, such as the ability to call an elevator car to travel in a specific, indicated direction.

Other interactive display images are possible as well. For example, with reference to FIG. 5C, the display image 514c is shown as a keypad or an alpha-numeric image/keyboard that a user can interact with. For example, the alpha-numeric image can be used to enable a passenger or user to input a security code to enable calling of a restricted elevator. In other configurations, the alpha-numeric image can be used to enable a user to call an elevator car to travel to a specific floor or destination.

The display and detection assembly 512 can include different types of projection devices and mechanisms. For example, in some embodiments, the display and detection assembly 512 can be configured to display different color light, flashing light, different brightness light, moving images, etc. Further, in some embodiments, the display and detection assembly 512 in accordance with the present disclosure can include audio components, for example a speaker, to provide audio instructions and/or indications. In such embodiments, one or more speakers can be integrated into the display and detection assembly 512 and/or the display panel 516. In other embodiments, the speakers can be configured separated from the display and detection assembly 512 and/or the display panel 516, such as in the ceiling or within another portion of an elevator door frame.

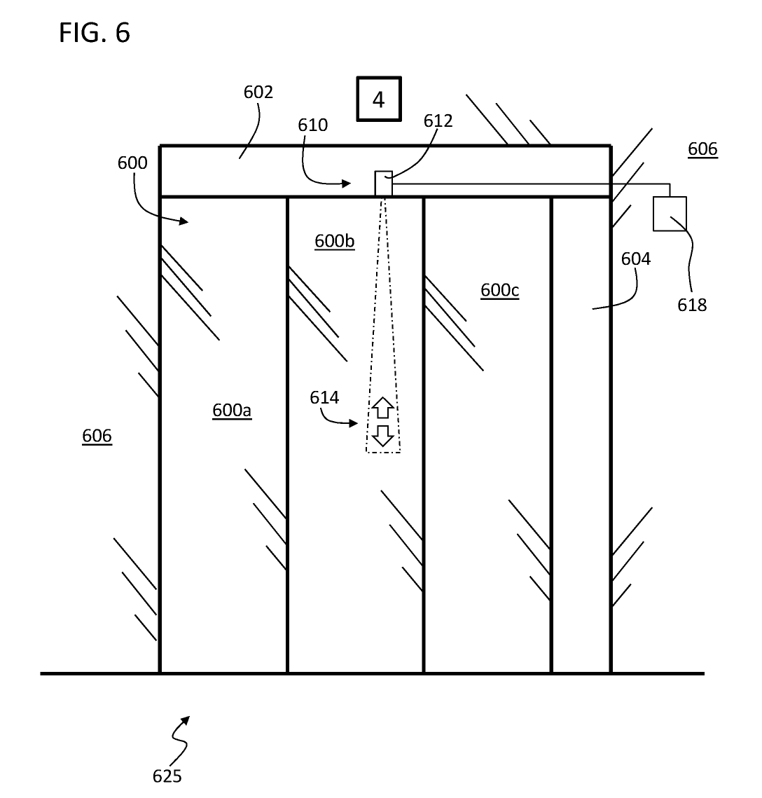

Turning now to FIG. 6, a schematic illustration of an elevator landing 625 incorporating another embodiment of the present disclosure is shown. As shown, the landing 625 includes an elevator landing door 600 that, as shown, includes three door panels 600a, 600b, 600c that can slide or translate to open when an elevator car is present at the landing door 600. The landing door 600 is housed within a door frame that includes a lintel 602 and one or more frame portions 604. As shown, the lintel 602 is positioned above the landing door 600 and the frame portion 604 is to the side and extends vertically from the floor to the lintel 602. The frame (e.g., the lintel 602 and the frame portions 604) is mounted within a wall 606 of the building in which an elevator system is located.

An elevator car can be called by a user (e.g., passenger) by operation of a virtual hall call panel system 610. The virtual hall call panel system 610, as shown, is a digital and virtual hall call panel system similar to that described above. The virtual hall call panel system 610 in accordance with the embodiment of FIG. 6 includes a display and detection assembly 612 that is configured to project a display image 614 on a door panel 600b of the elevator landing door 600. To achieve this, as shown, the display and detection assembly 612 is installed within or on the lintel 602. The display and detection assembly 612, as shown, is in communication with a controller 618 that is separate from the display and detection assembly 612.

In this embodiment, the display surface is a part of the door panel 600b. In some embodiments, the display surface on the door panel can be formed form a predetermined material, texture, paint, inclination (e.g., tilted surface), etc. that can be used for displaying the display image 614. However, in other embodiments, the display surface can be part of a traditional or existing surface of an elevator door panel.

As noted above, the virtual hall call panel systems of the present disclosure can be used to provide more than just arrows for calling an elevator car. For example, as noted, the virtual hall call panel systems can be used to automatically switch to and/or display an “out of service mode” in case of specific, predetermined events. For example, an automatic display change (e.g., from displaying up/down arrows to “out of service”) can occur when the elevator is in various maintenance and/or emergency modes of operation. Further, such automatic change in display can occur based on predetermined detected events/issues/system characteristics, an automatic routine that is launched remotely, etc. In such a change in operational mode, the controller can disable the detection feature of the display and detection assembly to prevent input by a passenger. At the same time, the display can be changed to a notification that includes information to inform potential passengers that the elevator is out of service or otherwise should not be used or is unusable. The notification display can be, for example, one or more of a symbol (e.g., as shown in FIG. 5B), text (e.g., as shown in FIG. 5A), a flashing light or buzzer, etc. Further, in such systems and configurations, the controller can automatically stop display of the “out of service mode” aspect (e.g., image, text, etc.) when the elevator is back in normal operation (i.e., reactivation of normal operation can be automatic as well).

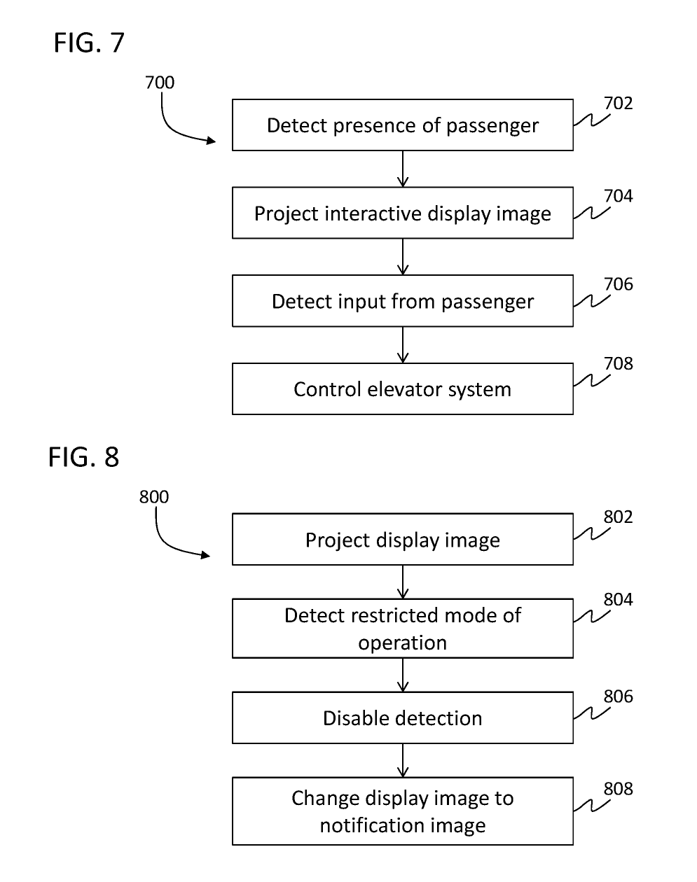

Turning now to FIGS. 7-8, flow processes for operating a virtual hall call panel in accordance with non-limiting embodiments of the present disclosure are shown. The flow processes 700, 800 can be performed using virtual hall call panel systems as shown and described above. Various components, such as processors, memory, etc. can be employed as will be appreciated by those of skill in the art. Further, the virtual hall call panel systems can include detection components, display components, and control components as known in the art.

At block 702, the virtual hall call panel system detects the presence of a passenger in proximity to a display panel or display location of the virtual hall call panel system. The detection can be performed using a proximity detector, such as an optical sensor or a floor pressure sensor.

Upon detection at block 702, the system displays an interactive display image on a display surface, as shown at block 704. The display surface can be any surface that is in proximity to the display system and at a location that is determined to enable detection by the system of a user's interaction with the interactive image. For example, two arrows (one up, one down) can be displayed on an elevator landing door frame where a traditional mechanical hall call button may be located. The display image can be an alpha-numeric image (e.g., a keypad), a listing of tenants within a building, a listing of floors that are accessible through an associated elevator car, etc.

At block 706, the system detects an input from a passenger. The input can be made in relation to the projected image. For example, a device that can detect the presence of a finger, hand, object, etc. at specific distance from a source (e.g., an optical position detector) can be used to determine the input from the user based on the location of the detected object.

From the detected input, the system generates a signal associated with the user input to appropriately communicate with and/or control an elevator car, as shown at block 708. For example, if an object is detected a first distance from a detector, the system can call an elevator car going upward relative to the current landing. However, if an object is detected a second distance from the detector (e.g., a distance greater than the first distance), the system can call an elevator car going downward relative to the current landing. Alternatively, if the display image is an alpha-numeric image (e.g., keypad) the signal can be related to enabling access to a limited access elevator, or can be used to lock access to the elevator. Other operations are possible based on user input, as will be appreciated by those of skill in the art, and the above example are provided for illustrative purposes and are not intended to be limiting.

Turning to FIG. 8, a virtual hall call panel system projects a display image on a display surface, as described herein, such as an interactive display image that can be used for operating the elevator system during normal operation (e.g., operate as an elevator call button). The display can be persistent or initiated by the presence of a passenger, as described above. As such, at block 802, the virtual hall call panel system displays an image on a display location. At block 804 a restricted mode of operation is detected and/or a signal indicating such restricted mode of operation is sent to the virtual hall call panel system from a remote location. At block 806, the virtual hall call panel system deactivates the detection function of the system such that a passenger cannot improperly call or operate the elevator system during the restricted mode of operation. At block 808, the virtual hall call panel system changes the prior interactive display image to a notification image, such as indicating the elevator is out of service, maintenance is being performed, indicating that a fire is present and use of the elevator is discouraged (in such operation the display may still be interactive to allow persons to call the elevator when needed—i.e., a disabled person that requires the elevator to evacuate, etc.), etc.

Advantageously, embodiments described herein provide virtual hall call panel systems that can be adapted to be installed in existing elevator system(s) without difficultly. That is, the components of the virtual hall call panel system can be relatively small and/or compact and thus can be retrofit into existing system. Further, advantageously, such compact components can allow installation and elevator hall calling in unique or customizable situations, e.g., unique architectures, small spaces, new and different geometries, etc.

Further, advantageously, embodiments provided herein can enable a cost reduction for operations as the virtual hall call panel systems allow a reduction in maintenance times by removing a need for a technician to place stickers or other indicators on each landing doors of an elevator system that is under maintenance. Further, advantageously, embodiments provided herein enable dynamic and/or customizable notifications, such that different situations can be addressed with an related and/or associated message and further prevent users from inadvertently using an out-of-service elevator.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A virtual hall call panel system for an elevator landing, the system comprising:
a display and detection assembly positioned proximate an elevator landing door, the display and detection assembly including a projection device and a detection device;
a display surface proximate the display and detection assembly configured to display a display image projected by the projection device of the display and detection assembly; and
a controller configured to receive input from the display and detection assembly, the controller configured to determine an input based on a detected object detected by the detection device and send a signal based on the input to control an elevator system.

2. The virtual hall call panel system of claim 1, further comprising a proximity sensor configured to detect the presence of a passenger within a predetermined proximity to the display and detection assembly.

3. The virtual hall call panel system of claim 2, wherein the controller is configured to control the display and detection assembly to project the display image when a passenger is detected within the predetermined proximity.

4. The virtual hall call panel system of claim 1, wherein the display surface is one of an elevator landing door frame or a wall of a building.

5. The virtual hall call panel system of claim 1, wherein the display image is at least one of (i) arrows indicating a direction to call an elevator car, (ii) an alpha-numeric keypad, or (iii) an informational notice.

6. The virtual hall call panel system of claim 1, wherein the controller is configured to change the display image projected by the display and detection assembly based on an operating mode of an elevator.

7. The virtual hall call panel system of claim 1, wherein the display image is at least one of an image, a drawing, a symbol, an icon, or text.

8. A method for controlling an elevator using a virtual hall call panel for an elevator landing, the method comprising:
displaying a display image on a display surface using a display and detection assembly positioned proximate an elevator landing door, the display and detection assembly including a projection device and a detection device;
detecting input from a passenger with the detection device, the input associated with the display image; and
transmitting a control signal to control an elevator based on the input.

9. The method of claim 8, further comprising detecting the presence of a passenger within a predetermined proximity to the display and detection assembly with a proximity sensor.

10. The method of claim 9, further comprising projecting the display image when a passenger is detected within the predetermined proximity.

11. The method of any of claim 8, wherein the display surface is one of an elevator landing door frame or a wall of a building.

12. The method of any of claim 8, wherein the display image is at least one of (i) arrows indicating a direction to call an elevator car, (ii) an alpha-numeric keypad, or (iii) an informational notice.

13. The method of any of claim 8, further comprising changing the display image projected by the display and detection assembly based on an operating mode of an elevator.

14. The method of any of claim 8, wherein the display image is at least one of an image, a drawing, a symbol, an icon, or text.

15. The method of any of claim 8, further comprising disabling the detection device based on an operating mode of an elevator.
